(19) United States
(12) Patent Application Publication
(10) Pub. No.: US 2017/0206276 A1
(43) Pub. Date: Jul. 20, 2017

(54) Large Scale Recommendation Engine Based on User Tastes

(71) Applicant: Iddo Gill, Hod Hasharon (IL)

(72) Inventor: Iddo Gill, Hod Hasharon (IL)

(21) Appl. No.: 14/995,994

(22) Filed: Jan. 14, 2016

(51) Int. Cl. G06F 17/30

(52) U.S. Cl. CPC G06F 17/30867; G06F 17/30598; G06F 17/30958

(57) ABSTRACT

Computer-implemented processes are disclosed for creating predictive recommendations based on large scale analysis of users tastes. One process involves detecting users tastes based on online activity and organizing these users into groups of users with similar tastes by applying graph manipulation algorithms and applying a clustering method on these graphs. Another process is disclosed for generating from these sub-graphs of similar groups of users a list of items users are most likely to show interest in based on groups' interests. A large scale solution is disclosed capable of processing large volumes of data in parallel generated from the activities of users online to create these recommendations. A system is described that takes all these artifacts to create a large scale recommendation system and collaborative filtering system. Yet another process is disclosed on how to target these groups of users with promotions through advertising networks.

### BACKGROUND OF THE INVENTION

The present invention is in the technical field of data structures, data analysis, graphs and social networks. And more specifically, an invention that detects and organizes user tastes into groups of similar users in order to create an improved recommendation system and collaborative filtering system.

Recommender systems or recommendation systems (sometimes replacing “system” with a synonym such as platform or engine) are a subclass of information filtering system that seek to predict the ‘rating’ or ‘preference’ that the user would give to an item. Recommender systems have become extremely common in recent years, and are applied in a variety of applications. The most popular recommender systems are for movies, music, news, books, research articles, search queries, social tags, and products in general.

Collaborative filtering is a technique used by some recommender systems. Generally, collaborative filtering is the process of filtering for information or patterns using techniques involving collaboration among multiple agents, viewpoints, data sources, etc. Applications of collaborative filtering typically involve very large data sets. Collaborative filtering methods have been applied to many different types of data including: Sensing and monitoring data, such as in mineral exploration, environmental sensing over large areas or multiple sensors; financial data, such as financial service institutions that integrate many financial sources; This system can also be found in ecommerce and web applications where the focus is on user data and user purchases.

Since users are faced with an overwhelming selection of products, content and/or services online, companies are challenged with a complex set of decisions in order to effectively determine what are the right products to offer to the right customer at the right time. The growth of the Internet has made it much more difficult to effectively extract useful insight from all the available online information. The overwhelming amount of data necessitates novel and improved mechanisms for efficient information filtering that can handle large scales.

### DESCRIPTION OF RELATED ART

The present invention relates generally to graph theory. Graph theory is the study of graphs, which are mathematical structures used to model pair wise relations between objects. A graph in this context is made up of vertices or nodes and lines call edges that connect them. Graphs are widely used in applications to model many types of relations and process dynamics in physical, biological, social and information systems. Accordingly, many practical problems in modern technological scientific and business applications are typically represented by graphs. A traditional social graph is a social structure made of users, groups (communities), or entities, generally referred to as “edges” (nodes) which are tied (connected) by one or more specific types of interdependency. Nodes are the individual actors within the networks, and edges are the relationships between the actors. The resulting graph-based structures are often very complex. There can be many types of edges between nodes. In its simplest form, a social graph contains nodes that represent people and edges that represent a certain relationship between the people.

The present invention relates to bipartite network projection. Bipartite network projection is an extensively used method for compressing information about bipartite networks or graphs. Bipartite graphs are a particular class of complex graphs, whose nodes are divided into two sets X (user) and Y (entity). Only connections between two nodes in different sets are allowed. For the convenience of directly displaying the relation structure among a particular set of nodes, bipartite graphs are compressed by one-mode projection. Therefore, the ensuing graphs contains nodes of only either of the two sets, and two X (or, alternatively, Y) nodes that are connected only when they have at least one common neighboring Y (or, alternatively, X) node.

The present invention relates to cosine similarity. Cosine similarity is a common measure for calculating similarity between two vectors of an inner product space that measures the cosine of the angle between them. Given two vectors of attributes, A and B, the cosine similarity, cos(θ), is represented using a dot product and magnitude and may be calculated according to the equation of Table 1. The resulting similarity ranges from −1 indicating an exactly opposite, to 1 indicating exactly the same result. A 0 result usually indicates independence, and in-between values indicate intermediate similarity or dissimilarity.

### SUMMARY OF INVENTION

This summary is provided to introduce a selection of concepts in a simplified form that are further described below in the Detailed Description section. This summary is not intended to identify key features or essential features of the claimed subject matter, nor is it intended to be used to limit the scope of the claimed subject matter.

In accordance with the current invention a method is provided for grouping users into communities of users with similar tastes. These communities provide insight into users interests and tastes enabling enhanced capabilities such as recommendations and improved search results for each user based on the user's belonging to a specific community of interests and tastes.

According to the embodiment of current invention, a system for grouping users into communities in large and complex network and graphs is provided. The system includes a computer processor and logic executable by the computer processor. The logic is configured to implement a method. The method includes calculating user tastes based on users online behavior, finding similarity between users and representing this information in a graph. The graph consists of nodes representing users and edges connecting different nodes (users). The edges contain weights representing the level of similarity of tastes between the two nodes (users), similarity score is derived from analyzing user behavior. This large graph representing users similarity is then processed to create smaller sub-graphs of users representing communities. A community represents a set of users with similar interests.

An embodiment provides a computing apparatus including a processor, memory and a storage medium. The storage medium contains a set of processor executable instructions that, when executed by the processor, run the computing apparatus to derive a graph of product relationships based on tastes of a community. The graph consists of nodes representing products and edges connecting different nodes (products). The edges contain weights representing the level of similarity between the two nodes (products). The similarity score is derived from the tastes users have shown for a product. This provides a unique view on products as they are viewed by the tastes of a specific community of users and can provide insight into how the community views products.

According to another embodiment of current invention, a system for intelligent recommendations and search results is provided. The system includes a computing apparatus including a processor, memory and a storage medium. The storage medium contains a set of processor executable instructions that when executed by the processor run the computing apparatus to derive recommendations and improved search results for a user based on the community they belong to and the products graphs representing community tastes of the products.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF DRAWINGS

The accompanying drawings, which are incorporated herein and constitute part of this specification, illustrate exemplary embodiments of the invention, and together with the general description given above and the detailed description given below, serve to explain the features of the invention.

FIG. 1 depicts a simple graph of ‘user to entity’ with edge weight representing user taste for entity

FIG. 2 depicts a graph of ‘user to entity’ with transformation to ‘user to entity category’

FIG. 3 depicts a ‘user to user’ graph after a bipartite projection

FIG. 4 depicts grouping of ‘user to user’ graph into user communities

FIG. 5 depicts graph node centrality

FIG. 6 depicts high level system flow chart

FIG. 7 depicts high level solution components

FIG. 8 depicts a system flow chart for receiving online activity

FIG. 9 depicts a system flow chart for recommendations

FIG. 10 depicts a system flow chart finding what is trending in a community

### DETAILED DESCRIPTION OF INVENTION

The various embodiments will be described in detail with reference to the accompanying drawings. Wherever possible, the same reference numbers will be used throughout the drawings to refer to the same or like similar parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

According to an embodiment of the present invention, a method enables to model a user set of tastes for a plurality of entities based on online activity. As used herein, a “user” may refer to a user, a consumer, a person, an automatic computer system. As used herein, an “entity” may refer to something having real, distinct, or virtual existence, virtually anything that a user may declare or otherwise demonstrate an interest in, a like towards, or a relationship with, such as, by way of example, a sport, a product, a clothing item, a book, an article, a Web site, a genre of music, a musical composer, a hobby, a business, a group, a third party application, a travel location, a person. As used herein, “online activity” is an action including but not limiting to: viewing an entity, searching for an entity, adding an entity in a shopping cart, purchasing an entity, rating an entity or recommending an entity. As used herein, a “taste” may refer to a preference, liking, disliking and affiliation. By way of example when for instance, a user purchases a specific mountain bike, it can be derived that generally, the user has a taste for mountain bikes and outdoor sports. User tastes can be aggregated to include multiple tastes based on multiple online activities on multiple entities.

According to another embodiment of the present invention, a set of online activities by a user on an entity can serve to define a user taste for an entity. Online activity such as rating, searching, viewing and purchasing a product can be aggregated to define the amount of interest or taste a user has for an entity. These online activities are aggregated by a computer system and a taste score is provided for the user of the entity. The taste score may be configured to include different weights for each online activity. In addition the taste score may be configured to run a statistical function including a set of online activities as input and additional input including but not limiting to entity attributes such as entity category and entity price; in addition to contextual attributes such as day of week, time of day or physical location. In addition, the weight of the edge between the user node and the entity node can be computed by the user engagement level with the entity; said user engagement level is determined by the amount of time a user spends interacting with an entity online and the type of activity performed. An additional computation for the affiliation level can be performed by a statistical function; said statistical function provides a value for the affiliation level based on looking at historical data and giving higher affiliation level to activities, sequence of activities and additional targeting parameters on entities that created more purchases of entities. Yet an additional computation for the affiliation level can be performed based on frequency, immediacy, length and duration of the interaction between the user with the entity.

The outcome of the taste score function is a number representing the affiliation between the user and the entity and can, be by way of example, a number between 1 and 5 where a return score of 1 is total dislike of the entity by the user and 5 meaning the user likes the entity very much.

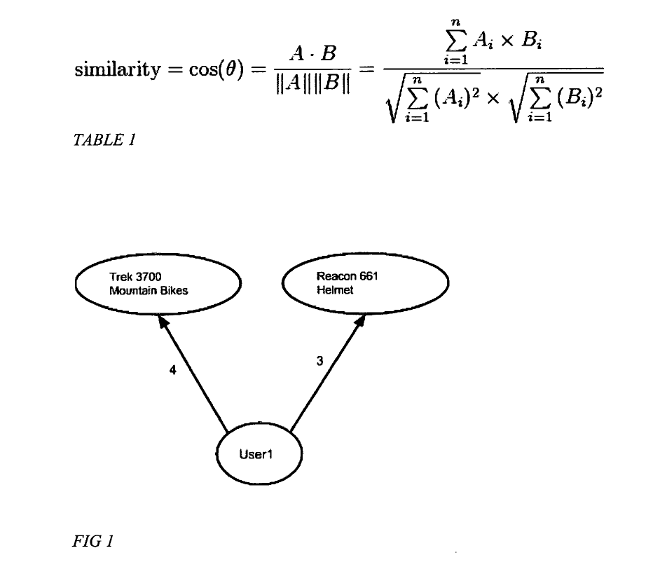

According to another embodiment of the present invention, all users tastes for all entities can be displayed in a graph where graph nodes includes two types: Users and Entities. The edge weights of the graph are the taste a user has for an entity defined by the taste score. This graph illustrates a set of user tastes for entities that are provided by a vendor or multiple vendors and is called ‘user to entity’ graph. As used herein, a “vendor” includes but not limited to a store, an online store, online web presence, online brand, displaying or offering any type of entity. FIG. 1 describes a ‘user to entity’ graph for a user that has shown interest in a mountain bike and a bike helmet. The weight on the edges connecting the nodes is the taste that system determined the user has for the entity.

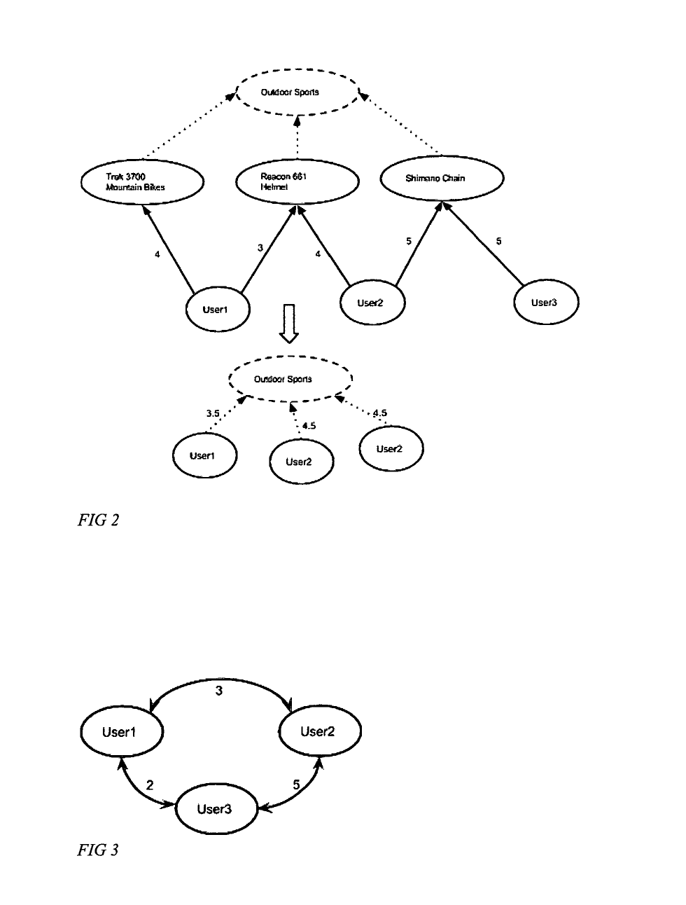

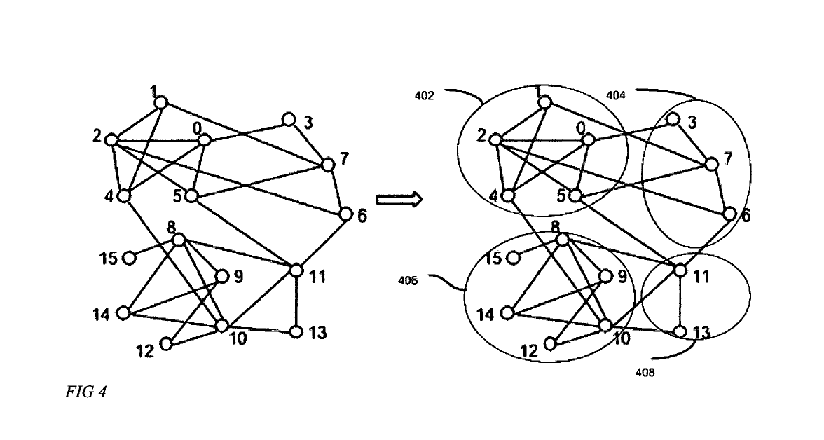

According to another embodiment of the present invention entities can be categorized. As used herein, a categorization may refer to the process in which entities are recognized, differentiated, and understood. Categorization implies that entities are grouped into categories, usually for a specific purpose. Categorization can be done by humans or automatically by a machine. When a user has shown a taste for a specific entity it can be inferred that the user also has taste for the entity category. User tastes for entity categories can be displayed in a graph where graph nodes are users and entity categories, and the edges represent an aggregated taste score that the user has for a category. This graph is called herein as the ‘user to entity category’ graph and is shown in FIG. 2. The aggregated taste score may be defined as an equation that receives all taste scores a user has for entities that belong to a specific category. The equation calculates a statistical function such as but not limited to average or weighted average of tastes for the aggregated tastes of entities in a specific category. The graph created represents a graph of ‘user to entity categories’ for a vendor or multiple vendors. FIG. 2 displays a transformation performed from a graph of a ‘user to entity’ into a new graph of ‘user to entity category’.

According to another embodiment of the present invention, by performing a bipartite projection on the graph ‘users to entities’, connections of users to users can be created by connecting users based on matching a set of plural tastes for entities. The bipartite projection is performed on users in the ‘user to entity’ graph creating a new graph with only one vertex of type user and edges connecting the users with edge weights representing user similarity. The bipartite projection can also be done on ‘user to entity category’ graph. The results of the two projections can be combined to create a better ‘user to user’ graph. Generally, the algorithm for the bipartite projections assumes a user has a certain amount of a resource (e.g., recommendation power) that is associated with each user node, and the weight Wij represents the proportion of the resource ‘j’ to distribute to ‘i’, where Wij is the edge weight between user node to entity node representing the taste the user has for this entity. Similarity between users is defined by a similarity function such as computing cosine similarity on the set of tastes the two users have for all entities. It is also possible to include additional data such as targeting parameters, entity meta-data with the affiliation level when calculating similarity, for finding users that have the same affiliation level for an entity or entity metadata and are from the same geographical location or use the same device. For that the bipartite projection function on ‘user to entity’ graph for calculating the similarity between two users receives as input user context including targeting parameters, entity meta-data and affiliation level between user and entity; said similarity function also receives a configuration specifying a scorecard function for each of the input values received; and the cosine similarity calculation is combined with the scorecard function applied on the input parameters thus creating a similarity function that includes cosine similarity and context. The combination of cosine similarity with scorecard function enables the flexibility of calculating users similarity not only based on user taste for an entity but also on the additional targeting parameters and entity metadata. By way of example assuming similarity is done on user's entity taste and geographical location, the scorecard function may receive the radius considered ‘close’ as a any distance within a 10 mile radius. By way of example, if the distance is within a 10 mile radius the scorecard returns 1 for distance coefficient, for any additional 5 mile distance the scorecard reduces the distance coefficient result by 0.2; therefore for a 20 mile distance between users the distance coefficient will be 0.6. The distance coefficient is multiplied with the result of the cosine similarity function computed which is between −1 and 1 on user's tastes on entities therefore reduces the similarity result based on the distance. The of the similarity function in this case is only if the users like the same entities and they are physically close will they be considered similar. The same type of logic can be applied to all context information such as by way of example entity color, entity price range, user time of day. The result of bipartite projection that are calculated with cosine similarity and scorecard function creates affiliations between users that may give preference to certain context attributes. The same similarity functions can be applied for ‘entity to entity’ projection.

The invention utilizes a specialized graph computation engine capable of inferring complex recursive properties of large graph-structured data. In the case of the bipartite transformation from the ‘user to entity’ into the ‘user to user’ graph, the amount of data generated to represent the result reaches very high volumes. For 10,000 users that are connected to the same entity the amount of edges generated to represent the ‘user to user’ graph is 10,000×10,000 which amounts to 100 million edges. This is due to the fact that each user influences every other user. For 250,000 users connected in the ‘user to user’ graph, the number of edges may reach 6.25*10̂10. To maintain and calculate algorithms on such a large graph, a graph parallel system is used to partition and distribute the computation by replicating the computing tasks, and cloning the data chunks on different computing nodes across the computing cluster combined. In addition a large storage component is used to persist the results.

A simple example is a ‘user to entity’ graph of multiple users that have a taste for mountain bikes, mountain bike helmets and mountain bike chains as shown in FIG. 2. A graph is created with vertices of type users and entities with edges connecting users to entities and edge weights expressing user taste for the entity. This graph is transformed to a graph with vertices of type users and entity categories with edges connecting users to entity categories and edge weights expressing user taste for an entity category. A bipartite projection on ‘user to entity category’ graph creates a user similarity graph with the edges representing the similarity between users for entity categories. This graph contains all user nodes with edges connecting users that have similar tastes. The bipartite graph transformation of ‘user to entity category’ is optional and is done when matching multiple user to the same entity is sparse. When there are sufficient matches in the ‘user to entity’ graph with multiple users matching the same entity, bipartite transformation is done on ‘user to entity graph’ and produces results in a similar manner.

According to another embodiment of the present invention, a grouping can be performed on the ‘user to user’ graph creating communities of users with similar tastes. Typically, the structure of the ‘user to user’ graph is nearly fully connected, with almost all users belonging to a single large connected graph. By performing graph analysis, meaningful clusters can be realized, creating sub-graphs of strongly connected users with similar tastes and similar context attributes referred to herein as ‘user to user communities’ graph based on the strength of the edge connections between the users. The problem of community detection requires the partition of a graph into communities of densely connected nodes, with the nodes belonging to different communities that are only sparsely connected. The typical size of a large ‘user to user’ graph can include millions of nodes and many billions of edges. Processing this graph to create user communities in this scale demands a method to retrieve comprehensive information from large graphs. The following algorithm shows, by way of example, an algorithm that efficiently finds high modularity partitions of large networks and unfolds a hierarchical community structure for the graph. The algorithm is divided into two phases that are repeated iteratively. Input into an algorithm generates a graph of N nodes. Initially, a different community is assigned to each node. The initial partition creates as many communities as there are nodes. Then, for each node neighbors' ‘j’ of ‘i’ and evaluated, and the gain of modularity that would take place by removing ‘i’ from its community and by placing it in the community of ‘j’ is applied. The node ‘i’ is then placed in the community for which this gain is maximized, but only if this gain is positive. If no positive gain is possible then, ‘i’ stays in its original community. Modularity is designed to measure the strength of division of a network into modules (also called groups, clusters or communities). Networks with high modularity have dense connections between the nodes within modules but sparse connections between nodes in different modules. This process is applied repeatedly and sequentially for all nodes until no further improvement can be achieved and the first phase is then complete. The second phase of the algorithm consists in building a new network whose nodes are the communities found during the first phase. To do so, the weights of the links between the new nodes are provided via the sum for the weight of the links between the nodes in the corresponding two communities. Once this second phase is completed, it is then possible to apply the first phase of the algorithm to the resulting weighted network and to iterate. The number of passes of first and second iteration can be configured. Each iteration of the algorithm is stored in persistent storage and creates a hierarchical view of the ‘user to user’ communities. Additional known community detection algorithms exist and can be used for community generation on the ‘user to user’ graph. FIG. 4 shows an outcome of performing ‘user to user’ graphs transformation into ‘user to user community’ graph. The result of this algorithm is that similar users are placed in a group of users with similar tastes to similar entities and with similar context attributes, achieved due to the calculation of similarity between users that includes cosine similarity and scorecard function, and grouped with the clustering algorithm described.

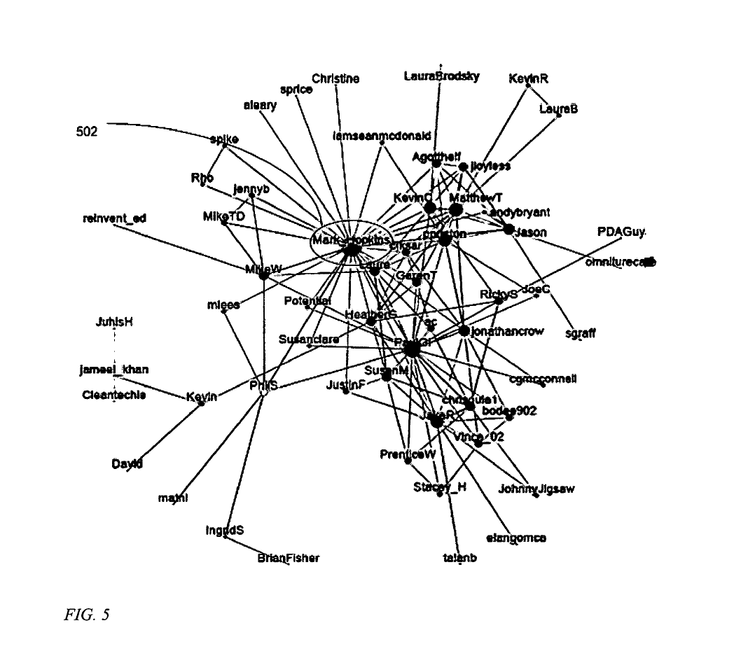

According to an additional embodiment of the present invention, the ‘user to user community’ graph structure that is created can provide insight into user tastes. By researching the structure of the users within a given community, valuable insight can be discovered. By way of example, node centrality for a given community can provide insight into trending tastes within the community. The centrality of a node can be used as a measure to determine the relative importance of a node within a graph. Node centralities may be used to determine which nodes (users) are important in the graph, in order to understand influencers and mavens of the community. By way of example in FIG. 5 node 502 is a highly central node (user), and can be used to determine this user as highly influential within a community. By looking up the entities of interest for a central node, node centrality may be used for recommending relevant entities for a specific user within a community displaying currently trending entities within the community as defined by a highly influential user. Other graph attributes can be used for good recommendations and prediction on users tastes. By way of example, finding the nearest nodes to a specific node means finding the most similar users to a specific user. By sharing entities of interest between these two users, good entity recommendations can be provided.

According to an additional embodiment of the present invention, it is possible to perform a bipartite projection on entities in the ‘user to entity’ graph to create a graph of entity type nodes with edge weights connecting entities representing similarity between entities as defined by user tastes. The similarity function used for the bipartite projection uses cosine similarity in the same manner as the ‘user to user’ bipartite projection described above. This new graph is called herein the ‘entity to entity’ graph. The ‘entity to entity’ graph displays similarity between entities by connecting two entities with an edge (edge weight is a number representing similarity between the two entities). In addition, node attributes may include the information on the entity such as average node rating by users, link to where the entity can be found and meta data of the entity such as color and price. The bipartite projection can be performed in several levels. Generally, the entire ‘user to entity’ graph creates an ‘entity to entity’ graph of all entities for all users. In addition bipartite projection can be performed on the user community level creating an ‘entity to entity’ graph for specific communities. The community level ‘entity to entity’ graph provides more focused results on how the community views the entities. By way of example for a specific community that is interested in outdoor sports, several mountain bikes are located in the ‘entity to entity’ graph. The highest rated mountain bike in the ‘entity to entity’ graph for this community shows the pair of mountain bikes most liked by the community, and by exploring the edges connected to this mountain bike can also show other mountain bikes or biking equipment that are most similar to these them as the users of this community experience.

According to an additional embodiment of the present invention, a search engine is provided for returning relevant entities to users. Search results can serve as user recommendations and real time automatic personalization and reflect results matching user tastes. The search can be initiated by the user providing a search query. In addition, the search query can be generated automatically by a vendor system having integrated with the recommendation system and searching for a recommendation for a user. The search method returns results by combining user taste derived from the graphs described above with other typical search parameters such as, by way of example, entity metadata and additional contextual information. More specifically the following data is generated by the system in previous steps and can be used for the search method: ‘user to user’ graph, ‘user to user community’ graph, general level ‘entity to entity’ graph, community level ‘entity to entity’ graph. In addition the system combines typical search capabilities such as user context, entity metadata, and explicit keywords. The combination of these inputs provides a novel recommendation and personalization capability returning results for a user based on user tastes, similar users tastes and the users' community tastes in addition to typical search capabilities. Combining typical search with user and community tastes provides a way to focus the results and giving priority to entities of general interest to the user out of the plurality of returned entities. By way of example, the following search method can be executed to create a recommendation, by analyzing the ‘user to user community’ graph data the search may refer to finding highest node centrality in the user's community and returning entities relating to this node. Graph attributes such as high node centrality identify community mavens that may try out products earlier than other community members providing unique and relevant results to the search. In addition, using the community level ‘entity to entity’ graph in the search returns the set of entities most relevant in the users community, in the priority defined by the community. As used herein, a “context” may refer to a set of circumstances that surround a user in an online situation. By way of example, this may include the time of day, the device used by a user, and the physical location of user. Context attributes can also include entity metadata, which are attributes describing an entity. By way of example entity metadata may includes ‘shirt’ with the ‘color: black’. Context attributes can be stored on the edge of the user to entity edge as a place to store this information. The context attributes can later be used by the search for prioritizing and filtering returned entities which enables returning most relevant entity results. By way of example, a restaurant search done by a mobile device returns a list of restaurants by user's tastes in physical proximity to the user. Another example, a black shirt search returns a list of black shirts matching user's tastes in clothing. A sorting algorithm is also provided for sorting the items returned by the search engine based on a variety of community preferences such as, by way of example, highest rated entity for a community, the most similar user preferences to the current user, and based on community mavens' preferences. Accordingly, queries are executed over entity metadata as well as the community information of users, thereby providing several benefits. First, search systems and methods of the present invention utilize community based information in conducting indexing and searching activities and are capable of locating a relevant entity even though the entity does not contain the exact wording or spelling provided by a user's query. Second, the search systems and methods of the present invention can harness the community information to improve the relevant scoring and ranking of entities, providing more relevant results to users. Moreover this method can provide real recommendations for a user based on trending entities within the community that are not necessarily being actively searched by the user but that are of interest to the user.

According to the present invention, user reputation, trust values and followers may be defined for users within a given community through implicit and explicit actions. Users belonging to the same community have an implicit association. By way of example, users belong to the same community or are in proximity to each other in the ‘user to user’ graph have an implicit trust relationship. The trust connection can be made regardless of prior knowledge between the two users, it can be done by similarity of tastes between the two users. For example, where two users share the same opinion and have common interests, an assumption may be made that there is a degree of trust between the users, based on the similarity computed for the pair of users. The similarity score may be interpreted as a trust or reputation value between the two users. An explicit trust action can be performed by two users based on a request initiated by one of the users to the other that is accepted. Users with trust connection may have additional communication capabilities amongst themselves such as sharing entities, sharing pictures and videos of entities and following the activities of a user.

According to another embodiment of the present invention, a search method is provided for connecting users in a community, by connecting them as community peers. A user may search for a peer with similar tastes or a peer with a specific interest. The system may return a list of peers answering to the request performed by the user. The user may choose a peer from the list and try to connect further by initiating any one of the following actions, such as, offering to a peer to be in a trust status. Peers may be connected upon acceptance of a peer's offer to connect. When peers are connected they can communicate in different forms such as, opening a chat between the peers for communicating through messages, raising questions about entities of interest, sharing pictures or videos of entities, recommending entities of interest and following a user's online activity. For any item shared, either text, picture or video other users can like or dislike the share. The peers capability offers a social network capability to the system. The social network connections are established based on similar tastes and not necessarily through prior acquaintances. The search is performed on the calculated graphs: the ‘user to user’ graph, the ‘user to entity’ graph, the ‘user to user community’ graph and the ‘entity to entity’ graph. The search algorithm parses the user query for finding peers and traverses the relevant graph for returning a result list of peers. By way of example, a user asks to see a list of most similar users to him that bought mountain bikes. The search algorithm parses the query to understand the requested search. The algorithm first traverses the ‘user to user community’ graph and finds edges connected to the user with the highest values. This traversal creates a list of users. For each user on the list go to the ‘user to entity’ graph and find all users that bought a mountain bike by retrieving metadata information for the entity that is stored in the entity node; and return the list of peers to the user that performed the query.

According to another embodiment of the present invention, the system may store all online activity of users and may get real time updates of these activities. This information is stored for each user for each community, and can therefore derive the online location of each user that is interacting with the system. A client side software is connected to the present invention service and may provide this information in a text or visual manner showing the communities behavior in real time. Community behavior may include the following activities of users within a community in the vendors site, mobile app or social network such as viewing an entity, purchasing an entity and rating an entity. By showing aggregated data a user can get a sense of the community activities within a vendor's site, and see which entities attract the most views, interests, rating and purchases using this software. This capability may be extended for a cross vendor view showing the entities that attract the most views and purchases by users in a community for multiple vendor sites. Using the software, this type of information can guide the users on what is happening for a specific time online and which vendors and entities are attracting the most activity by community.

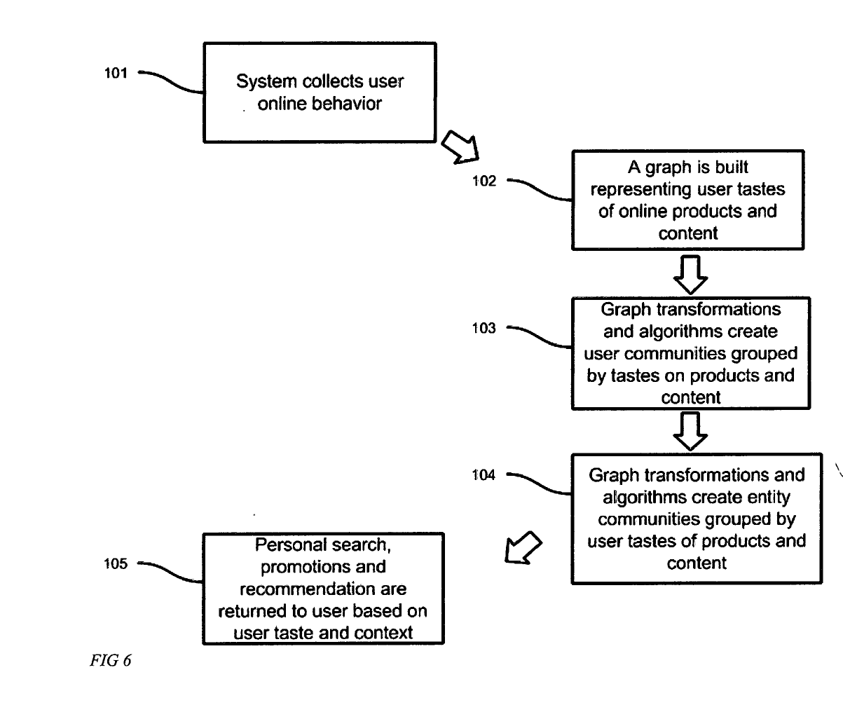

The high level process of the system is as follows: users interact with online entities, by way of example, with apps, online ecommerce sites and social site creating online activity. This interaction causes the input of online activity into the system. More specifically, the user interacts with an online system or service and shows interest in a specific entity. In FIG. 6, the input into system 101 includes user online activity. These activities may include any of the activities discussed above. These activities are defined as signals in the invention. The current invention executes several data processing steps in order to achieve the data structure that groups users into communities of similar tastes, groups entities into groups of similar entities, and provides recommendations based on these tastes.

Algorithm phases are as follows and as shown in FIG. 6:

a. First phase 102 of algorithm is a program creating a ‘user to entity’ graph. If entities are categorized then a program may be executed to create a ‘user to entity category’ graph.
b. Second phase 103 of algorithm is a program that performs a bipartite projection on the ‘user to entity’ graph and ‘user to entity category’ graph created in first phase 102 and creates a new ‘user to user’ graph. The next step is to create communities on the ‘user to user’ graph that creates a new ‘user to user community’ graph.
c. Third phase 104 of algorithm is a program that performs a bipartite projection on ‘user to entity’ graph created in phase 102 and creates a new graph of the ‘entity to entity’ graph. This is the global level ‘entity to entity’ graph. In addition the ‘user to user community’ graph is also used as input to create the community level ‘entity to entity’ graph for each community.
d. Fourth phase 105 of algorithm performs a search combining graphs from blocks 102, 103, 104, entity metadata and context to return personalized recommendations on entities and peers.

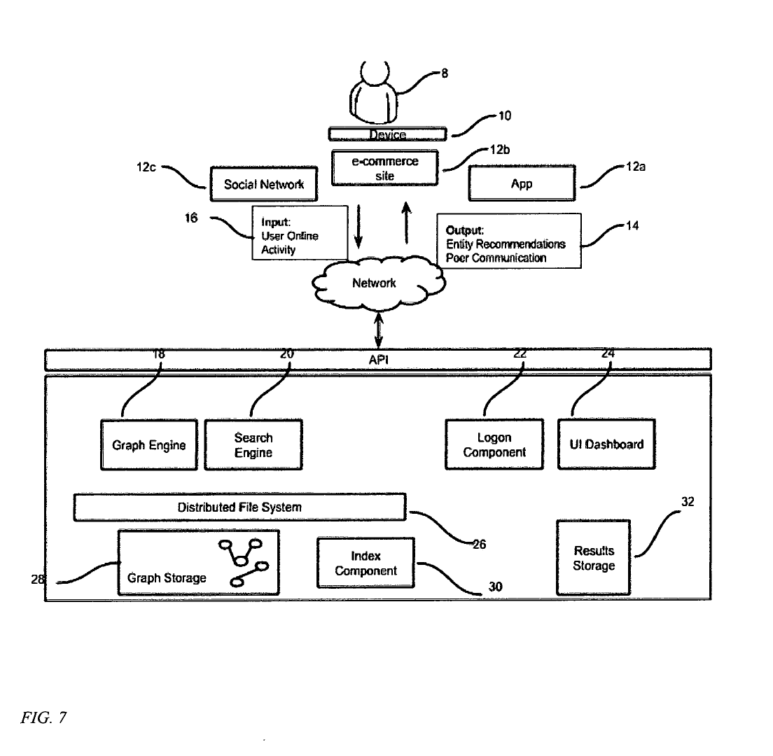

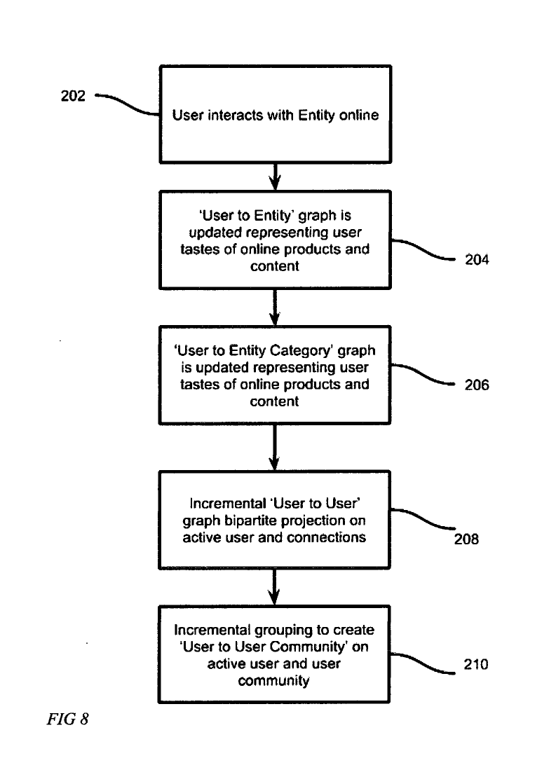

FIG. 7 illustrates the system components that a user 8 invokes with each online activity and other system functions. In a high level, user online activities are provided as input and entity and/or peer recommendations are provided as output. The entities returned as output may be, for example, a list of recommendations for clothing, a list of links to reading content, and a restaurant recommendation identified by the search engine. When potential peer matches are returned as output, peers can be provided, for example, in a list form or as links that the user can click on to obtain more information about the potential peer.

In FIG. 7 user 8 may use a client device to perform online activity. Each client device 10 may generally be a computer, computing system, or computing device including functionality for communicating (e.g., remotely) over a computer network. Users are identified by the system of present invention using a digital identifier of the device they are connecting from or by logging into the system. Client device 10 in particular may be a desktop computer, laptop computer, personal digital assistant (PDA), tablet, in- or out-of-car navigation system, smart phone, wrist-mounted mobile computing device or other cellular or mobile device, or mobile gaming device, among other suitable computing devices. Client device 10 may execute one or more client applications, such as a web browser (e.g., Microsoft Internet Explorer, Mozilla Firefox, Apple Safari, Google Chrome, and Opera etc.), to access and view content over the Internet. In particular implementations, the client applications allow a user 8 of client device 10 to enter addresses of specific network resources to be retrieved, such as resources hosted by e-commerce sites 12a. These addresses can be Uniform Resource Locators (URLs). In addition, once a page or other resource has been retrieved, the client applications may provide access to other pages or records when the user “clicks” on hyperlinks to other resources. By way of example, such hyperlinks may be located within the web pages and provide an automated way for the user to enter the URL of another page and to retrieve that page. More particularly, when a user 8 at a client device 10 desires to view a particular web page hosted by online sites such as an e-commerce site, a social site or through an e-commerce mobile app, the user's web browser, or other client-side structured document rendering engine or suitable client application, formulates and transmits a request to web servers 12a, social networking system 12b and mobile apps server 12c. The request generally includes a URL or other document identifier, user identifier, as well as metadata or other information. By way of example, the request may include an action on an entity such as viewing an entity, information identifying the user, such as a user ID, as well as information identifying or characterizing the web browser or operating system running on the user's client computing device 10. The request may also include location information identifying a geographic location of the user's client device or a logical network location of the user's client device, as well as timestamp identifying when the request was transmitted.

Computer program code for carrying out operations for aspects of the present disclosure may be written in any combination of one or more programming languages, including an object oriented programming language such as Java, Scala, C++ or the like and conventional procedural programming languages, such as the “C” programming language or similar programming languages. In addition software open source big data frameworks may be used including Hadoop, Spark, GraphX or the like. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In FIG. 7 graph engine 18 receives online activity input and starts a process to update the graph structures as described in the flowchart in FIG. 8. The graph algorithm is performed as a mapreduce process in communication with the distributed file system such as Hadoop distributed file system 26. Hadoop distributed file system is presented here merely as an illustrative and non-restrictive example. Essentially any suitable distributed file system may be employed. In accordance with at least one embodiment of the invention, indexing takes place via Lucene 30 (a free/open source information retrieval software library originally created in Java and supported by Apache). Inverted index maps can be employed to identify pairs where attributes are equivalent to predetermined values, and indicate their occurrence among the data. Lucene is presented here merely as an illustrative and non-restrictive example. Essentially any suitable indexing system may be employed. Online activity received by the system may include entity description and metadata such as price, color, genre, size, publication, location, or any other attribute that helps to describe the entity. The metadata information of the entity is inserted into the Lucene indexing solution for the ability to later retrieve this data quickly upon request. The indexing files may be stored on the Hadoop distributed file system. Search and recommendation requests are processed by the search engine 16, in communication with the Lucene indexing component 30 and with the Hadoop distributed file system 26. In accordance with at least one embodiment of the invention, given a query for recommendation of entities or peers from device 10, the query is parsed by search engine 20 and values are looked up in the Lucene index 30 (itself associated with Hadoop or other distributed file system 26). Hadoop 26 also stores all the graph data and definitions. Peer search may be performed on the ‘user to user’ graph that contains edges connecting user to user representing the similarity between the users. Graph traversal may be employed for deriving recommendations for peers by finding user similarity based on edge weight and graph structure.

The output may be displayed on a software that may be downloaded or otherwise installed on a mobile computing device. For example, the software may be downloaded from a Google Play™, store or iTunes™ digital stores for use on Android™ tablets or iPads™, respectively. Once installed on the computing device, the software may be linked to applications also installed on the computing device. For example, the software may be linked to Facebook™, Twitter™, Amazon™, Netflix™, and other common apps that utilize user accounts associated with particular individuals. The software may be configured to cause the computing device to display, render, or otherwise present information and/or graphical elements that represent retrieved user recommendation information. In addition the software links to these apps and allows the apps to open the software through a framework of custom URL schemes. For example, integrating with Facebook allows users to navigate directly to the recommendation software from the Facebook™ app via these URLs, so the computing device executing the software may render entity recommendation information relating to an entity currently viewed in Facebook™.

In addition integration with third party vendors Web site can be done where input and output are provided by the vendor by means of integration into the Web page which calls the service the system provides as a Software as a Service (SaaS). This service enables the vendor Web site to call a method for the online activity a user performs as input and receiving recommendations for the user as output. The output may be integrated within the site content, by way of example, as a ‘recommended for you’ banner with recommended entities as part of the vendors Web page. In case there are multiple users on a single device the user might be asked to choose his user from several users on the same device and logon as his user into the system block 22. User information is sent with each system call and is identified by the system as originating from the user for logging of online activity and recommendations.

In an exemplary use case, a user has shown interest in purchasing a bike helmet for mountain bike riding. For that, the user goes into several online outdoor sports stores and investigates different helmets by brand, price and different reviews. The online store is integrated with the recommendation system and continuously sends online activity information on the products the user viewed including user id and product metadata. The system receives these online activity signals and does the following steps in the background:

a. Recommendation system receives online activity signals and entity description as a service call shown in FIG. 8 block 202.
b. Create an updated ‘user to entity’ graph connecting user to additional helmet entities by adding edges to the graph between user and helmet entity block 204. Create an updated ‘user to entity category’ graph increasing user taste score for mountain bike equipment category
c. Update the Lucene index component with entity metadata provided as part of the input.
d. Performs a bipartite projection on ‘user to entity’ graph and ‘user to entity category’ graph creating an updated ‘user to user’ graph increasing scores of edges between the user and similar users. In this case the user will be connected more strongly to users that are looking at mountain bike equipment right now and specifically mountain bike helmets block 206.
e. The communities graph algorithm is executed creating an updated community for the ‘user to user’ graph. The user is now in a community with the same interests, with other users that are looking for bike helmets.

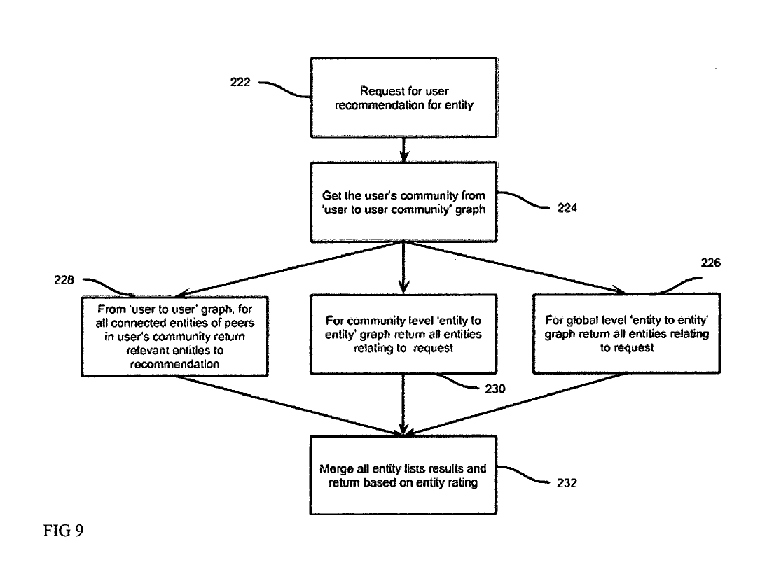

The user does not reach a decision and closes the online browsing session. Later he opens his mobile device and checks a Facebook post on bike equipment, and specifically looks at a mountain bike helmet. The user clicks on a link from Facebook that opens the recommendation software with a list of mountain bike equipment personal recommendation. The system generating these recommendations does the following steps in the background:
f. The system receives a recommendation request for a user specifying the user is looking at a specific Reacon 661 mountain bike helmet as shown in FIG. 9 block 222.
g. The system goes to ‘user to user community’ graph and returns the community identifier for the user and all peers belonging to this community block 224.
h. For global level ‘entity to entity’ graph return entities that are most similar to Reacon 661 mountain bike helmet. These are all entities that are connected with an edge to the Reacon 661 helmet node block 226.
i. From community level ‘entity to entity’ graph, return entities that are most similar to Reacon 661 mountain bike helmet. These are all entities that are connected with an edge to the Reacon 661 helmet node block 230.
j. For all peers directly connected to the user return a list of entities filtered by query word block 228.
k. Merge three lists from point ‘h’, ‘i’ and ‘j’ and prioritize based on entity priority which is stored on entity node.

The merged list is presented in the software on the user's device and the user can flip through the list of recommended entities. When a user clicks on an item he is directed to the site the entity appears on.

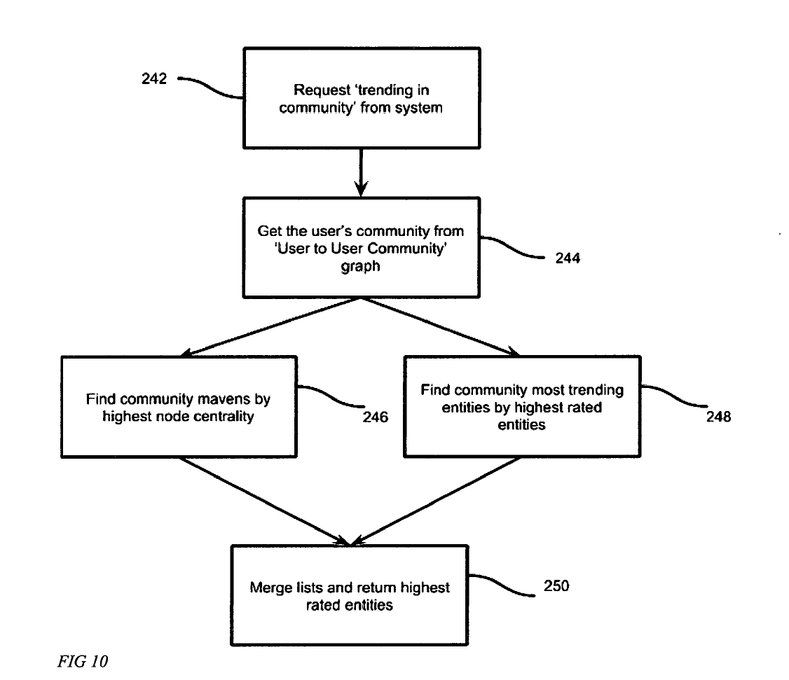

The software has additional functionality like ‘show trending entities’ which show the most trending entities for the user's community. When the user requests the ‘show trending entities’ of his community the system generating these recommendations does the following steps in the background:
l. A request is generated by the user for a recommendation of trending entities in the community as shown in FIG. 10 block 242.
m. For the user's community find the mavens which are the users with highest node centrality in the ‘user to user’ graph within the community. Return list of highest rated items for this maven user block 246.
n. For the user's community find the highest rated entities in the community level ‘entity to entity’ graph block 248.
o. Merge the two lists from points ‘l’ and ‘m’ above sorted by entity priority and return the list to the software to present to the user block 250.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

According to a further embodiment of the present invention, a graphical user interface is provided for in depth analysis on users, communities and entities stored results FIG. 7 blocks 24 and 32. The system stores the following structures in a persistent distributed file system storage to support the graphical in-depth analysis. The structures stored are ‘user to user’ graph, ‘user to community’ graph, global level ‘entity to entity’ graph, community level ‘entity to entity’ graph. The computing device may be configured to render or otherwise display dashboard front-ends that depict information retrieved using the dashboard software. In particular, dashboard front-ends may be rendered to show community behavior, by way of example, showing a graph of communities and aggregated data on preferred entities for each community.

According to a further embodiment of the present invention, for all recommendations of entities provided by the system, the system will keep statistics on response rate of user clicking on the recommendation and raise or lower score of entity accordingly within a community. This enables for successful entities within a community to get higher scores based on users response and receive priority in future recommendations.

The supported systems may function in a Software as a Service (SaaS) model. SaaS is a capability provided to the vendor to use the invention services running on a cloud infrastructure. The vendor does not manage or control the underlying cloud infrastructure including network, servers, operating systems, storage, or even individual application capabilities, with the possible exception of limited user-specific application configuration settings.

Broadly contemplated herein, in accordance with at least one embodiment of the invention, is the use of a mapreduce cluster that works as live archival solution in a SaaS. In accordance with at least one embodiment of the invention, the map-reduce cluster is a Hadoop cluster.

In accordance with at least one embodiment of the invention, an enterprise can effectively perform analytics over very large amounts of data as a SaaS, while data on the Hadoop or other distributed file system can be used to build graphs of users tastes and identify communities in the cloud. In addition recommendations of entities and peers can be performed based on this data.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. A computer system, comprising:
a first component that identifies user activity online by tracking activity performed by the user on entities, targeting information and entity metadata; said component does tracking by running on the user's device and sending these activities as signals to an online service; and
a second component that is an online service that receives and aggregates the signals sent by first component; and
a third component that generates bipartite graph of users and entities from said aggregated signals where users are nodes and entities are nodes and the weight between the two nodes represents the affiliation between the user and entity that are connected thus creating a ‘user to entity’ graph; and
generates a bipartite graph of users and entity categories where users are nodes and entity categories are nodes and the weight between the two nodes represents the affiliation between the user and entity category that are connected thus creating a ‘user to entity category’ graph; and
performs a weighted bipartite projection on the user nodes in the ‘user to entity’ graph and generates a ‘user to user’ graph; each of the weights of the new ‘user to user’ graph created by the method represent the similarity level between the two users; and
performs a weighted bipartite projection on the entity nodes in the ‘user to entity’ graph and generates a new ‘entity to entity’ graph; and the weights between two entity nodes of the new ‘entity to entity’ graph created by the method represent the similarity level between two entities; and
applies a clustering algorithm on ‘user to user’ graph thus creating multiple sub-graphs representing groups of users with similar tastes; said output includes multiple ‘user to user community’ sub-graphs, each graph with users as nodes and edges between user nodes with weights depicting user's affiliation level; and
applies a clustering algorithm on ‘entity to entity’ graph thus creating multiple sub-graphs representing groups of entities that are similar; said multiple sub-graphs, each with entities as nodes and edges between entity nodes with weights depicting entities' affiliation level.

2. The method of claim 1 wherein signals are any of a plurality of activities that a user performs on web pages or apps such as view an entity, check entity size, add entity to shopping cart; and any of a plurality of activities that a user performs on a social site such as like, change status, post, dislike, and share of an entity.

3. The method of claim 1 wherein signals include user activity offline, such as purchases at physical stores that are aggregated in a backend system of the store and sent as signals to the service or passed as an aggregated file of purchase activities.

4. The method of claim 1 wherein targeting information includes a plurality of parameters from the user's device; said parameters include geographical location coordinates obtained from the GPS or WIFI positioning via user's device, type of device user is using, the time of day and day of week the activity is done.

5. The method of claim 1 wherein entity metadata includes any of a plurality of parameters identifiable on an entity page being viewed by a user including category of entity, sub-category of entity, price of entity, brand of entity, or any dates relating to entity; said parameters are derived from text describing the entity on the page, the entity URL, categories available within the entity page and any other information that can be derived from the page.

6. The computer system of claim 1, wherein the second component comprises a plurality of physical servers, each of which (1) receives on a secure connection signals generated by the component running on user device, and (2) store the information as events in a persistent storage.

7. The method of claim 1 where on the edge between the user node and the entity node in ‘user to entity’ graph, user activity and context information including targeting information and entity meta-data are stored based on the user performing an activity on an entity including geographical location of user, device type of user, time of the day and day of week of user activity on entity, entity category, entity sub-category, entity brand, entity price and entity description.

8. The method of claim 1 where the weight of the edge between the user node and the entity node in ‘user to entity’ graph representing the affiliation level is computed based on user interaction with the entity and on activity context information; said computation includes several methods including a statistical method on historical activities of users interaction with entities leading to conversions, scorecard functions defined for different activities, engagement functions and time sensitive functions.

9. The method of claim 1 wherein the bipartite projection function on ‘user to entity’ graph for calculating the similarity between users or entities include calculations that combine cosine similarity and a scorecard function on entity activity and context information that generate a similarity score between users.

10. A computer-implemented method of claim 1 wherein a clustering algorithm is applied on the ‘user to user’ graphs, thus creating multiple ‘user to user community’ sub-graphs representing groups of users with similar tastes and with similar activity context; said sub-graphs created each with users as nodes and edges between user nodes, with weights on edges depicting user's affiliation level, and a list of targeting parameters and entity meta-data characterizing the sub-graph.

11. A computer-implemented method of claim 1 wherein a clustering algorithm is applied on the ‘entity to entity’ graphs, thus creating multiple sub-graphs representing groups of similar entities with similar activity context; said sub-graphs created each with entity as nodes and edges between entity nodes with weights depicting entity's affiliation level, and a list of targeting parameters and entity meta-data characterizing the sub-graph.

12. A computer-implemented method that builds for each users sub-graph created in claim 10 a new ‘user to entity’ graph based on the interaction of the users with the entities, and performs a bipartite projection on the entity nodes and generates an ‘entity to entity’ graph; the weights between two entity nodes of the new ‘entity to entity’ graph created by the method represents the similarity level between the two entities for each sub-graph of users; said ‘user to entity’ and ‘entity to entity’ graph are stored in the data repository in an indexed graph format.

13. A computer-implemented method that takes the output of claim 1 and stores the graphs and sub-graphs generated in the data repository on disk, in a graph format in an indexed graph format.

14. A computer-implemented method of providing personal recommendations, comprising:
a first component passing a request for recommendations over a network from an initiating user computing device associated with this user; said recommendation request containing a search phrase, set of entities, or entity meta-data; and
a second component that is an online recommendation service configured to receives the search request associated with a user identifier; and to search the associated data values stored in the data repository in graph form, to generate an output list of entities that answer the search request returning entities that are predicted to be of interest to the user, said input and output lists each including multiple items; and
incorporating the item recommendations into a return result of recommended entities, and transmitting the result back to the user computing device for presentation to the user.

15. The method of claim 14 wherein recommendations for users are done by a search method performed on the ‘user to user community’ sub-graph the initiating user belongs to; the search method finds the user nodes with highest node centrality in this sub-graph, and returns the entities with highest affiliation level of this high centrality user nodes; the user nodes with highest node centrality represent users that are considered community mavens as they are active and are central in the community, and can predict the interest of other group members.

16. The method of claim 14 wherein recommendations for users are done by a search method performed on the ‘user to user community’ sub-graph the initiating user belongs to; the search method finds the user's node closest neighbors in the sub-graph, these nodes represent users that have the highest similarity to the user being recommended, and returns a list of entities with highest affiliation level of these user's neighbors nodes; the user nodes closest to the user being recommended represent users that are considered most similar to this user, and can predict their interest.

17. The method of claim 14 wherein recommendations for users are done by a search method performed on the ‘user to user community’ sub-graph; said search method may use a combination of algorithms comprising of: (1) giving higher priority to actions performed on entities in a sequence and based on sequence sensitive activities of users within a group, (2) on time sensitive function that give higher priority to activities on entities with high affiliation level and that were performed more recently; and (3) filtered on already purchased entities by the user and availability of entity in stock.

18. The method of claim 14 wherein recommendations for users are done by a search method performed on an ‘entity to entity’ sub-graph which the entity the initiating user is viewing belongs to; the search method finds the entity nodes with highest node centrality, and the node's closest neighbor in the sub-graph the entity being viewed by the user belongs to and returns these entities as recommendations; the combination of these algorithms finds entities that are attracting the most activity, and can predict the interest of the user.

19. The method of claim 14 wherein recommendations for users are done by a search method performed on the ‘user to user community’ sub-graph the initiating user belongs to that receive user's location and viewed entity; the search method finds and entities that are in the user's sub-graph predicted to be of interest to the user and that are physically near the user's location within a certain radius.

20. The method of claim 14 wherein recommendations returned from the search method are filtered by entity category to show complementary entities by filtering results to be within the same category or same sub-category of entity being viewed.

21. The method of claim 14 wherein recommendations returned from the search method are filtered by entity category to show alternate entities by filtering results to not be within the same category or same sub-category of entity being viewed.

22. The computer system of claim 14, wherein the component comprises a physical server that is configured to generate personalized item recommendations in real time in response to requests for recommendations creating a personalized experience for the user in the website, app or social page; the computer system is updated in real-time with activities on entities by users to show up to date recommendations.

23. The computer system of claim 14, wherein the second component comprises a plurality of physical servers, each of which stores (1) a replicated copy of graph structure that includes said data values, and (2) executable code that uses the search algorithm to generate entity recommendations.

24. A computer-implemented method of creating targeted promotions in an advertising network, comprising:
a component configured to receives a request to target an audience with a promotion; and
to use the associated data of the audience to create targeting parameters characterizing this audience online behavior to pass to the advertising network; and offering the entities that are predicted to be of interest to the target audience to be displayed in the ad media.

25. The method of claim 24 wherein audience refers to a group of users belonging to a ‘user to user community’ sub-graph as described in claim 7, and parameters characterizing audience refers to the targeting parameters of the ‘user to user community’ sub-graph as described in claim 7.

26. The method of claim 24 where the offered entities in the ad media are entities that are predicted to be of interest to the users using the method in claim 15.

27. The method of claim 24 wherein the component is configured to receives a request to target an entity or plurality of entities and to use the associated data of the entity in the ‘user to entity’ sub-graph the entity belongs to, to find the users most likely to be interested in this entity; and to create targeting parameters characterizing these users behavior online to pass to the advertising network, offering said entities in the ad media predicted to be of interest to the targeted users.

28. The method of claim 24 wherein targeting parameters refers to parameters passed to the advertising network that runs the promotion that include information on the users derived from the users behavior online including a combination of the following parameters: remarketing lists of entities viewed by these users, geographical location of users, ad display schedule based on users online behavior, device type used by user.

29. The method of claim 24 wherein targeting promotions refers to internal promotions showed in a dedicated area in the web site, social network and app where each user is shown a promotion with entities predicted to be of interest to them.

30. A computer-implemented method of providing the ability for two users to connect as community peers comprising:
a user performs a search for a peer with similar tastes or a peer with a specific interests, the system returns a list of peers answering to the request performed by the user from the user's sub-graph, and the user may choose a peer from the list and try to connect further by offering to the peer to be in a trust status; thus connecting the peers and enabling communication between them; and
a service to share community behavior between community members in real time in a text or visual manner; said community behavior includes activities of users within a community at vendors site, mobile app or social network such as viewing an entity, purchasing an entity and rating an entity; by showing aggregated data a user can get a sense of the community activities, and see which vendors sites and which entities attract the most views, interests, rating and purchases, guiding the users on what is happening online and which vendors and entities are attracting the most activity by community in real-time.

31. The method of claim 30 wherein the search is performed on user's ‘user to user community’ sub-graph that contains users with similar tastes, returning a list of users to the user performing the search.

32. The method of claim 30 wherein enabling communication includes opening a chat, raising questions about entities of interest, sharing pictures or videos of entities and entity usage, recommending entities of interest and following a user's online activity creating a joint shopping experience.
